(19) United States
(12) Patent Application Publication
(10) Pub. No.: US 2009/0183247 A1
(43) Pub. Date: Jul. 16, 2009

(54) SYSTEM AND METHOD FOR BIOMETRIC BASED NETWORK SECURITY

(75) Inventors: Mark Edward Kasper, Greenacres, FL (US); Christopher James Martinez, Lake Worth, FL (US)

Correspondence Address: PILLSBURY WINTHROP SHAW PITTMAN LLP, P.O. BOX 10500, MCLEAN, VA, 22102, US

(73) Assignee: 11i Networks Inc., Boca Raton, FL (US)

(21) Appl. No.: 12/013,347

(22) Filed: Jan. 11, 2008

(51) Int. Cl. H04L 9/32

(52) U.S. Cl. 726/7

(57) ABSTRACT

Systems and methods of securing access to a network are described. Access to the network is secured using multifactor authentication, biometrics, strong encryption, and a variety of wireless networking standards. Biometrics include fingerprints, facial recognition, retinal scan, voice recognition and biometrics can are used in combination with other authentication factors to create a multi-factor authentication scheme for highly secure network access. Requests that require access to secured network resources may be intercepted and a captive portal page returned to challenge a user. Biometric information returned in response to the portal page is used to authenticate the user and determine access rights to the network.

### BACKGROUND OF THE INVENTION

1. Field of the Invention

The present invention relates generally to networking security and more particularly to the use of biometrics for securing a wireless network.

2. Description of Related Art

Biometric security refers to using “something you have” as an authentication factor. Some common biometrics are fingerprint, facial recognition, voice recognition, retinal scans, and hand geometry. Biometric security requires additional hardware and software due to the nature of the data captured by this factor.

Conventional networking systems rely on a variety of methods for security. Some of the more popular methods include:
i) Remote Authentication Dial Up Service (RADIUS)
ii) Virtual Private Network (VPN)
iii) Multifactor authentication
iv) Encryption
v) IEEE 802.11i Wireless Network standard

However, various problems exist with conventional wireless computer networks because wireless computers or other device do not connect to a physical port but, instead, connect to a network through wireless communication. In conventional wired computer, networks may base user authentication, at least in part, on the location of a wired device. In particular, the network may assume that a user's presence at the wired device indicates that the user has provided credentials to physically access a building in which access to the computer network is available via known physical ports and known network cabling. In the case of wireless devices, a computer or other client device may be located anywhere within reach of the wireless RF signal, including at locations beyond the point where physical security is typically enforced.

### BRIEF SUMMARY OF THE INVENTION

These and other problems are resolved in certain embodiments of the invention that require the provision of biometric credentials as part of the network authentication process. Regardless of the location of the wireless client device, physical security can be enforced. Aspects of the invention address problems related to any of a variety of network technologies including IEEE 802.11 wireless LAN and IEEE 802.16 (WiMAX).

In some of these embodiments, network authentication using a remote authentication dial in user (“RADIUS”) service is the de facto standard. The addition of biometric authentication to a captive portal page involves customizing the captive portal and a gateway to allow for the biometric software to authenticate the user. Performing a match using biometric data involves far more computation power than a simple password match. A specialized, stand-alone server, called a match server, does the biometric match. The match server can be deployed on the same network as the RADIUS server; but more appropriately, the match server is deployed on a remote network. This is done for security reasons since match servers are very expensive and contain very sensitive data. Thus, deploying the match server remotely offers an extra layer of security.

### BRIEF DESCRIPTION OF THE DRAWINGS

FIG. 1 illustrates a method for authentication according to certain aspects of the invention.

FIG. 2 provides a flow chart describing a method of biometric challenge according to certain aspects of the invention.

FIG. 3 shows a flow chart detailing an example of the biometric aspects of an authentication process.

FIG. 4 shows a flow chart illustrating the operation of a captive portal.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. For the purposes of this description, systems and methods that use RADIUS for authentication will be described.

In certain embodiments of the invention, biometric authentication can be added to a captive portal page. A captive portal page may be presented in response to a user request. For example, a request for a target web page may be intercepted and handled in a manner that effectively alters the request such that a substitute web page is presented to the user. This can be accomplished by altering the DNS address resolution response message such that the IP address for the web server hosting the target webpage is replaced with the IP address for the web server hosting the substitute web page. The substitute webpage is herein referred to as the captive portal page.

Typically, a gateway, server or controller device is configured to provide a substituted response to the DNS address request. For the purpose of this description, the term “gateway” will be used to refer to the device or system responsible for substituting DNS responses. In one example, a RADIUS server may be used to control and/or manage operation of a gateway that alters IP addresses as described above. The RADIUS server may exchange control messages with the gateway to influence the substitution of IP addresses such that a captive portal page is returned in the place of a requested target page. In certain embodiments, the gateway and RADIUS server can be integrated into a single system. It will be appreciated that the single system may also be distributed over plural physical devices.

In certain embodiments, a captive portal page is presented to the user instead of a requested web page in order to obtain an interaction with the user. Interaction can include an activation of one or more simple acknowledgment buttons, entering of a usemame and/or password, credit card payment information and so on. According to certain aspects of the present invention, a captive portal page is displayed for the purpose of capturing biometric credentials from a user.

In certain embodiments, any of a number of mechanisms may be employed for translating user biometric data into a format and structure suitable for authentication evaluation. For example, a user thumbprint or iris geometry scan can be translated to an alphanumeric representation that can subsequently be included in an authorization request message. It should be noted that the results obtained from an authentication decision can also include or indicate authorization rights for resources available to the user. The security of the alphanumeric representation of a biometric characteristic can be maintained by using a secure communication protocol such as the Secure Socket Layer protocol or other available techniques for encryption, etc.

In certain embodiments, a captive portal and the gateway are provided to facilitate biometric authentication of a user. Performance, configuration and programming requirements of biometric matching can be satisfied using a specialized, stand-alone server (referred to herein as a “match server”) to perform biometric matching. The match server can be deployed on the same network as a RADIUS server although, in certain embodiments, the match server is deployed on a remote network as desire or necessary to accomplish the objectives of the application of the technology. Reasons for remote deployment of a match server can include a need for increased security and the need for reduced deployment costs, both of which needs can be satisfied through an economical centralizing of matching operations. Centralization can significantly reduce system cost and maximize security of sensitive data necessarily maintained by match servers.

In certain embodiments, the captive portal page uses one factor authentication, such as a usemame/password. In some cases, a two-factor authentication may be used. For example, a voucher number in combination with predetermined information known to the user knows can be required for authentication. For the purposes of this description a captive portal page that utilizes multi-factor authentication, including biometrics is described.

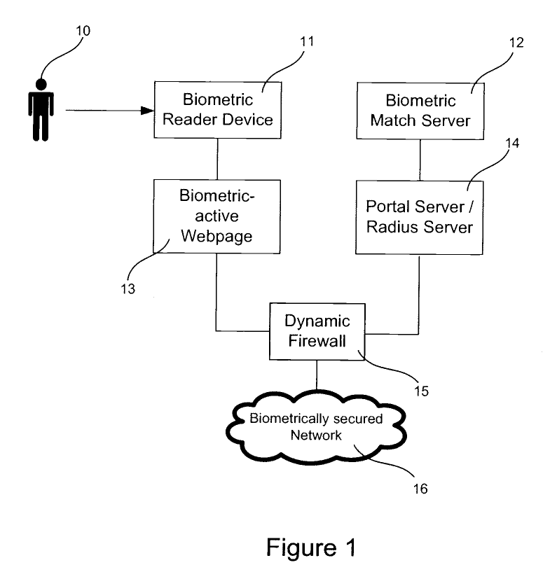

Referring to FIG. 1, certain embodiments comprise a biometric reader 11 or other device capable of capturing a biometric attribute of user 10. Biometric attributes can include fingerprints, retina scan, iris scan, voice recognition, face recognition, biochemical identifiers and so on. Biometric reader 11 may be controlled or connected to an application. In one example, the application can be initiated by and/or embedded in a web page 13 accessed by user 10. In some embodiments, the application may prompt user 10 to activate biometric reader 11 and in at least some embodiments, the application may automatically activate a reader 11. For example, the application may activate a camera connected to a computer and may further capture an image of the user that includes the desired biometric identifier.

Certain embodiments comprise a firewall 15 that controls access to network 16. In certain embodiments, firewall 15 permits access to secured network 16 to a restricted group of network addresses. Security policy on the dynamic firewall may be governed based on authentication of users based on biometric data among other factors. To obtain one of the restricted addresses, a user must be biometrically matched to records maintained by an authentication system that may include a match server 12, a captured portal page server and a RADIUS server 14 or agent of a RADIUS server 14. Thus, RADIUS server 14 can be employed to manage user authentication whereby match server 12 cooperates with RADIUS server 14 to perform biometric authentication of users.

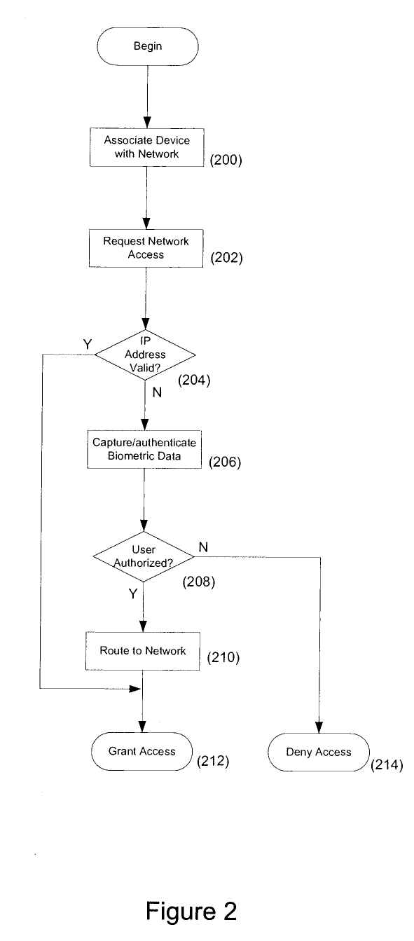

Referring also to FIG. 2, certain embodiments include a process by which a user may gain access to secured network 16 using a captive portal page. At step 200, a device establishes an association with, for example, a wireless network through an access point and requests access to the network at step 202. The association step 200 can optionally include assigning network addresses, device authentication and configuration of encryption and other communication functions and facilities. In some instances, the device may already have a valid address, having been recently authenticated by an access point of the network prior to a disconnection or transition between access points. However, and as necessary, the device can be assigned a local address by a DHCP server or RADIUS server. In one example, the network address may have the format 10.10.0.x or 192.168.0.x.

When the associated device attempts an HTTP request using a web browser at step 202, the system may intercept and redirect the request at step 204 to another local server such as a captive portal. Redirection may be accomplished using one of various available methods. For example, redirection can occur when the IP address of the portal page server is substituted for a host IP address within a DNS request response message directed to the wireless device. Such substitution can be implemented as a form of network address translation (“NAT”). The captive portal may then perform a biometric authentication process at step 206. At step 208, the user may be denied access 214 based on the result of authentication. Otherwise, the user device may be routed at step 212 to the secured network 16. The device may be routed by updating information maintained at the firewall 15. If, at step 204, a valid IP address is reported by the wireless device, access may be granted to the secured network 16 at step 210.

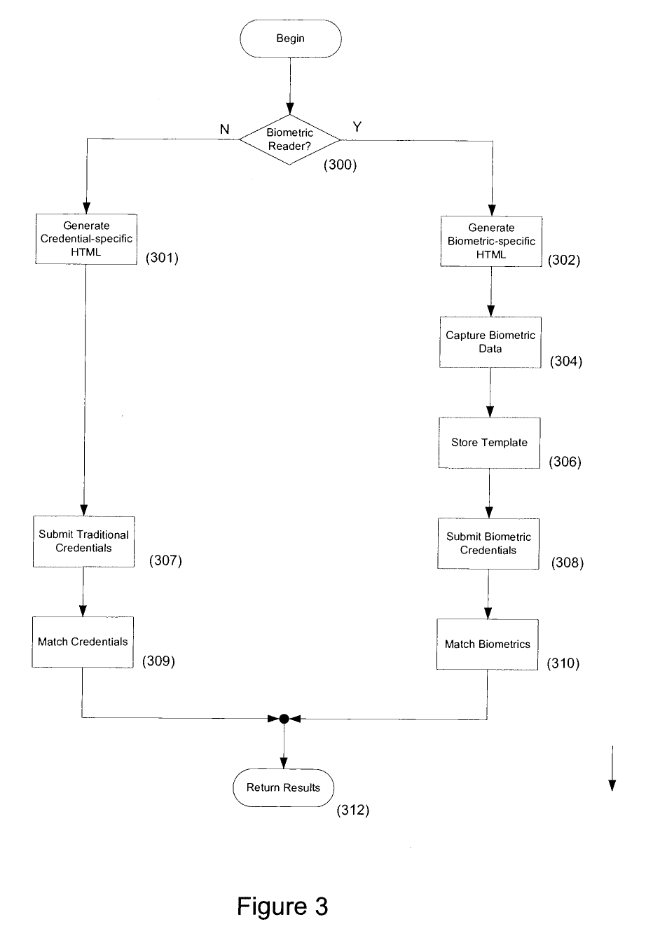

FIG. 3 illustrates one example of an authentication process used in certain embodiments of the invention. The authentication process may be configured to authenticate uses by biometric and other means. Thus, at step 300, it is determined whether the device can provide biometric identification through, for example, a biometric reader 11. If the device can supply biometric identification, then at step 302 the user may be challenged to provide biometric identification. In the example, the challenge may comprise a message, web page and/or an applet and the challenge may be generated for obtaining credentials other than the biometric authenticating information. In certain embodiments, the challenge is constructed as an HTML web page can be created to control and/or monitor gathering of identifying credentials or other information at step 304. At step 306, certain characteristics of the captured biometric data may be extracted and stored as representative of the user. The extracted data may conform to a template of known points or distinguishing features according to the type of data. For example, where fingerprint information is captured, a certain number of points of interest (minutiae) in the fingerprint may be mapped and used for verification/identification of the user.

The biometric credentials may be stored at step 306 and transferred to an authentication server at step 308. At step 310, the authentication server attempts to match the identifying information with previously recorded authenticated credentials associated with system users. The results of the authentication may be returned, to a RADIUS server or other server at step 312.

In certain embodiments, if it is determined at step 300 that the device has limited or no biometric authentication capability then, at step 301, a web page may be generated to obtain more conventional credentials. For example, the user may be required to provide one or more user identifications including passwords and authentication keys. Credentials obtained from the user may then be transmitted at step 307 for authentication at step 309. The results of the convention credential-based authentication may be returned at step 312.

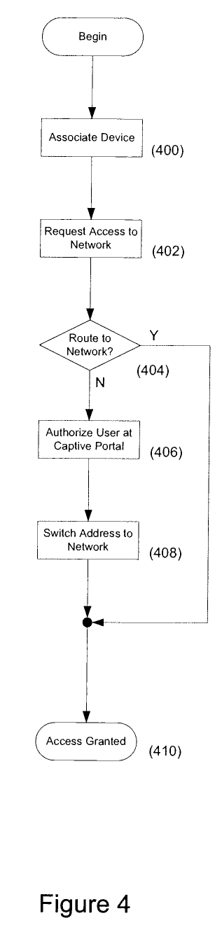

With reference to FIG. 4, one example of communications redirection is shown. At step 400 in the example, a device creates an association with a wireless network and is assigned a local address, typically by a DHCP or RADIUS server. This address is typically a local address having a format such as 10.10.0.x or 192.168.0.x. When the associated device attempts to access a network at step 402, using for example, an HTTP request from a web browser, the system may redirect the request to another local server such as a captive portal at step 404. Redirection may be accomplished using various methods and has the general effect of cloistering the wireless device within a local network until authentication is confirmed. Thus an HTTP request directed to a network server or other resource may be captured and redirected to a local server, typically a captive portal that provides authentication. It will be appreciated that the local server may be local in virtual networking terms and can be physically distant from the wireless device. The captive portal performs an authentication process at step 406 and returns the result of the authentication. Upon confirmation of user authentication, cloistering of the wireless device is ended at step 408, when the address of the wireless device is added to a list of devices authorized to access the network. Thereafter, network access requests such as HTTP requests will typically be forwarded to intended destinations and will typically not be redirected within the local network. Thus, when the device has been successfully authenticated, then at step 410, the device can be switched onto the biometrically protected network, typically by updating the policy table for the device's IP address on the local gateway.

### Additional Descriptions of Certain Aspects of the Invention

Certain embodiments of the invention provide systems and methods for authenticating a user of a secured network, comprising intercepting a request for network access by the wireless device, responsive to the request, challenging a user of the wireless device to provide a biometric identification, and permitting the user to access a portion of the secured network upon matching a response from the user with a known sample of the biometric information. In some of these embodiments, the step of intercepting includes receiving the request from the wireless device and redirecting the request to an authentication server. In some of these embodiments, the authentication server is a RADIUS server. In some of these embodiments, the challenging includes returning a captive portal page as a first response to the request. In some of these embodiments, the captive portal page is returned by the authentication server. In some of these embodiments, the response includes credentials of the user. In some of these embodiments, the credentials include a password. In some of these embodiments, the permitting includes updating a policy of a firewall. In some of these embodiments, the policy is associated with an address assigned to the wireless device. In some of these embodiments, the request is an HTTP request. In some of these embodiments, the response is encrypted. In some of these embodiments, the biometric information includes a fingerprint. In some of these embodiments, the biometric information includes an iris scan. In some of these embodiments, permitting the user to access a portion of the secured includes determining access rights of the user based on the biometric information.

Certain embodiments of the invention provide systems and methods for segregating a network, comprising an authentication server configured to match known biometric identifiers with biometric information submitted by a user, a gateway configured to intercept a first request from the user requiring access to a secured portion of a network and a captive portal page server configured to issue a challenge to the user in response to the first request, wherein the biometric information is submitted by the user in response to the challenge and the gateway grants access to the secured portion of the network when a match is determined to exist between the known biometric identifiers with biometric information submitted by the user. In some of these embodiments, the authentication server includes a RADIUS server. In some of these embodiments, the gateway includes a NAT gateway. In some of these embodiments, the gateway is adapted to redirect the request to the captive portal page server unless the user has been authenticated. In some of these embodiments, the gateway is configured to intercept a second request from the user when the second request requires access to a different secured portion of a network.

Certain embodiments of the invention provide computer-readable media that store instructions executable by one or more processing devices to perform the systems and methods described above.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method for authenticating a user of a secured network, comprising:
intercepting a request for network access by the wireless device;
responsive to the request, challenging a user of the wireless device to provide a biometric identification; and
permitting the user to access a portion of the secured network upon matching a known sample of biometric information with a response to the challenging received from the user.

2. The method of claim 1, wherein the intercepting includes:
receiving the request from the wireless device; and
redirecting the request to an authentication server.

3. The method of claim 2, wherein the authentication server includes a RADIUS server.

4. The method of claim 2, wherein the challenging includes returning a captive portal page as a first response to the request.

5. The method of claim 4, wherein the captive portal page is returned by the authentication server.

6. The method of claim 1, wherein the response includes credentials of the user.

7. The method of claim 6, wherein the credentials include a password.

8. The method of claim 1, wherein the permitting includes updating a policy of a firewall.

9. The method of claim 8, wherein the policy is associated with an address assigned to the wireless device.

10. The method of claim 1, wherein the request is an HTTP request.

11. The method of claim 1, wherein the response is encrypted.

12. The method of claim 1, wherein the biometric information includes a fingerprint.

13. The method of claim 1, wherein the biometric information includes an iris scan.

14. The method of claim 1, wherein permitting the user to access a portion of the secured includes determining access rights of the user based on the biometric information.

15. A system for segregating a network, comprising:
an authentication server configured to match known biometric identifiers with biometric information submitted by a user;
a gateway configured to intercept a first request from the user requiring access to a secured portion of a network; and
a captive portal page server configured to issue a challenge to the user in response to the first request, wherein
the biometric information is submitted by the user in response to the challenge and the gateway grants access to the secured portion of the network upon matching the known biometric identifiers with biometric information submitted by the user.

16. The system of claim 15, wherein the authentication server includes a RADIUS server.

17. The system of claim 15, wherein the gateway includes a NAT gateway.

18. The system of claim 17, wherein the gateway is adapted to redirect the first request to the captive portal page server unless the user has been authenticated.

19. The system of claim 15, wherein the gateway is configured to intercept a second request from the user when the second request requires access to a different secured portion of a network.

20. A computer-readable medium that stores instructions executable by one or more processing devices to perform a method of, for authenticating a user of a secured network, comprising:
intercepting a request for network access by the wireless device;
responsive to the request, challenging a user of the wireless device to provide a biometric identification;
permitting the user to access a portion of the secured network upon matching a response from the user with a known sample of the biometric information.
